(19) United States
(12) Patent Application Publication
(10) Pub. No.: US 2025/0361084 A1
(43) Pub. Date: Nov. 27, 2025

(54) AN ACCESS STATION FOR AN AUTOMATED STORAGE AND RETRIEVAL SYSTEM

(71) Applicant: AutoStore Technology AS, Nedre Vats (NO)

(72) Inventor: Joakim Aleksander Myrbakken, Skudeneshavn (NO)

(21) Appl. No.: 18/874,662

(22) PCT Filed: Jun. 19, 2023
(86) PCT No.: PCT/EP2023/066439

§ 371 Date: Dec. 13, 2024

(30) Foreign Application Priority Data
Jun. 21, 2022 (NO) 20220709

(51) Int. Cl. B65G 1/04; B65G 1/06; B65G 1/137

(52) U.S. Cl. CPC B65G 1/0464; B65G 1/0485; B65G 1/065; B65G 1/1378

(57) ABSTRACT

An access station (600) for an automated storage and retrieval system, wherein the access station (600) comprises: —a frame structure (620); and —a drawer assembly (610) arranged in the frame structure (620), wherein the drawer assembly (610) comprises: —a drawer (611) for accommodating a storage container (106); —a lower link (612) pivotally coupled at a first end (612a) to the frame structure (620) and pivotally coupled at a second end (612b) to the drawer (611); and —an upper link (613) pivotally coupled at a first end (613a) to the frame structure (620) and pivotally coupled at a second end (613b) to the drawer (611); wherein the first end (613a) of the upper link (613) is arranged above the second end (613b) of the upper link (613), and the first end (612a) of the lower link (612) is arranged below the second end (612b) of the lower link (612); wherein the drawer (611) is movable between a receiving position (P_{R}) for receiving a storage container (106) from above, and a picking position (Pₚ) for presenting a storage container (106) to a user.

### FIELD OF THE INVENTION

The present invention relates to an automated storage and retrieval system for storage and retrieval of containers, in particular to an access station for presentation of a goods holder from an automated storage and retrieval system to a picker.

### BACKGROUND AND PRIOR ART

FIG. 1 discloses a prior art automated storage and retrieval system 1 with a framework structure 100 and FIGS. 2, 3 and 4 disclose three different prior art container handling vehicles 201,301,401 suitable for operating on such a system 1.

The framework structure 100 comprises upright members 102 and a storage volume comprising storage columns 105 arranged in rows between the upright members 102. In these storage columns 105 storage containers 106, also known as bins, are stacked one on top of one another to form stacks 107. The members 102 may typically be made of metal, e.g. extruded aluminum profiles.

The framework structure 100 of the automated storage and retrieval system 1 comprises a rail system 108 arranged across the top of framework structure 100, on which rail system 108 a plurality of container handling vehicles 201,301,401 may be operated to raise storage containers 106 from, and lower storage containers 106 into, the storage columns 105, and also to transport the storage containers 106 above the storage columns 105. The rail system 108 comprises a first set of parallel rails 110 arranged to guide movement of the container handling vehicles 201,301,401 in a first direction X across the top of the frame structure 100, and a second set of parallel rails 111 arranged perpendicular to the first set of rails 110 to guide movement of the container handling vehicles 201,301,401 in a second direction Y which is perpendicular to the first direction X. Containers 106 stored in the columns 105 are accessed by the container handling vehicles 201,301,401 through access openings 112 in the rail system 108. The container handling vehicles 201,301,401 can move laterally above the storage columns 105, i.e. in a plane which is parallel to the horizontal X-Y plane.

The upright members 102 of the framework structure 100 may be used to guide the storage containers during raising of the containers out from and lowering of the containers into the columns 105. The stacks 107 of containers 106 are typically self-supporting.

Each prior art container handling vehicle 201,301,401 comprises a vehicle body 201a, 301a, 401a and first and second sets of wheels 201b, 201c, 301b, 301c,401b,401c which enable the lateral movement of the container handling vehicles 201,301,401 in the X direction and in the Y direction, respectively. In FIGS. 2, 3 and 4 two wheels in each set are fully visible. The first set of wheels 201b,301b, 401b is arranged to engage with two adjacent rails of the first set 110 of rails, and the second set of wheels 201c,301c,401c is arranged to engage with two adjacent rails of the second set 111 of rails. At least one of the sets of wheels 201b, 201c, 301b,301c,401b,401c can be lifted and lowered, so that the first set of wheels 201b,301b,401b and/or the second set of wheels 201c,301c,401c can be engaged with the respective set of rails 110, 111 at any one time.

Each prior art container handling vehicle 201,301,401 also comprises a lifting device for vertical transportation of storage containers 106, e.g. raising a storage container 106 from, and lowering a storage container 106 into, a storage column 105. The lifting device comprises one or more gripping/engaging devices which are adapted to engage a storage container 106, and which gripping/engaging devices can be lowered from the vehicle 201,301,401 so that the position of the gripping/engaging devices with respect to the vehicle 201,301,401 can be adjusted in a third direction Z which is orthogonal the first direction X and the second direction Y. Parts of the gripping device of the container handling vehicles 301,401 are shown in FIGS. 3 and 4 indicated with reference number 304,404. The gripping device of the container handling device 201 is located within the vehicle body 201a in FIG. 2 and is thus not shown.

Conventionally, and also for the purpose of this application, Z=1 identifies the uppermost layer available for storage containers below the rails 110,111, i.e. the layer immediately below the rail system 108, Z=2 the second layer below the rail system 108, Z=3 the third layer etc. In the exemplary prior art disclosed in FIG. 1, Z=8 identifies the lowermost, bottom layer of storage containers. Similarly, X=1 . . . n and Y=1 . . . n identifies the position of each storage column 105 in the horizontal plane. Consequently, as an example, and using the Cartesian coordinate system X, Y, Z indicated in FIG. 1, the storage container identified as 106′ in FIG. 1 can be said to occupy storage position X=17, Y=1, Z=6. The container handling vehicles 201,301,401 can be said to travel in layer Z-0, and each storage column 105 can be identified by its X and Y coordinates. Thus, the storage containers shown in FIG. 1 extending above the rail system 108 are also said to be arranged in layer Z=0.

The storage volume of the framework structure 100 has often been referred to as a grid 104, where the possible storage positions within this grid are referred to as storage cells. Each storage column may be identified by a position in an X- and Y-direction, while each storage cell may be identified by a container number in the X-, Y- and Z-direction.

Each prior art container handling vehicle 201,301,401 comprises a storage compartment or space for receiving and stowing a storage container 106 when transporting the storage container 106 across the rail system 108. The storage space may comprise a cavity arranged internally within the vehicle body 201a,401a as shown in FIGS. 2 and 4 and as described in e.g. WO2015/193278A1 and WO2019/206487A1, the contents of which are incorporated herein by reference.

FIG. 3 shows an alternative configuration of a container handling vehicle 301 with a cantilever construction. Such a vehicle is described in detail in e.g. NO317366, the contents of which are also incorporated herein by reference.

The cavity container handling vehicle 201 shown in FIG. 2 may have a footprint that covers an area with dimensions in the X and Y directions which is generally equal to the lateral extent of a storage column 105, e.g. as is described in WO2015/193278A1, the contents of which are incorporated herein by reference. The term ‘lateral’ used herein may mean ‘horizontal’.

Alternatively, the cavity container handling vehicles 401 may have a footprint which is larger than the lateral area defined by a storage column 105 as shown in FIGS. 1 and 4, e.g. as is disclosed in WO2014/090684A1 or WO2019/206487A1.

The rail system 108 typically comprises rails with grooves in which the wheels of the vehicles run. Alternatively, the rails may comprise upwardly protruding elements, where the wheels of the vehicles comprise flanges to prevent derailing. These grooves and upwardly protruding elements are collectively known as tracks. Each rail may comprise one track, or each rail 110,111 may comprise two parallel tracks. In other rail systems 108, each rail in one direction (e.g. an X direction) may comprise one track and each rail in the other, perpendicular direction (e.g. a Y direction) may comprise two tracks. Each rail 110,111 may also comprise two track members that are fastened together, each track member providing one of a pair of tracks provided by each rail.

WO2018/146304A1, the contents of which are incorporated herein by reference, illustrates a typical configuration of rail system 108 comprising rails and parallel tracks in both X and Y directions.

In the framework structure 100, a majority of the columns 105 are storage columns 105, i.e. columns 105 where storage containers 106 are stored in stacks 107. However, some columns 105 may have other purposes. In FIG. 1, columns 119 and 120 are such special-purpose columns used by the container handling vehicles 201,301,401 to drop off and/or pick up storage containers 106 so that they can be transported to an access station (not shown) where the storage containers 106 can be accessed from outside of the framework structure 100 or transferred out of or into the framework structure 100. Within the art, such a location is normally referred to as a ‘port’ and the column in which the port is located may be referred to as a ‘port column’ 119,120. The transportation to the access station may be in any direction, that is horizontal, tilted and/or vertical. For example, the storage containers 106 may be placed in a random or dedicated column 105 within the framework structure 100, then picked up by any container handling vehicle and transported to a port column 119,120 for further transportation to an access station. The transportation from the port to the access station may require movement along various different directions, by means such as delivery vehicles, trolleys or other transportation lines. Note that the term ‘tilted’ means transportation of storage containers 106 having a general transportation orientation somewhere between horizontal and vertical.

In FIG. 1, the first port column 119 may for example be a dedicated drop-off port column where the container handling vehicles 201,301,401 can drop off storage containers 106 to be transported to an access or a transfer station, and the second port column 120 may be a dedicated pick-up port column where the container handling vehicles 201,301,401 can pick up storage containers 106 that have been transported from an access or a transfer station.

The access station may typically be a picking or a stocking station where product items are removed from or positioned into the storage containers 106. In a picking or a stocking station, the storage containers 106 are normally not removed from the automated storage and retrieval system 1, but are returned into the framework structure 100 again once accessed. A port can also be used for transferring storage containers to another storage facility (e.g. to another framework structure or to another automated storage and retrieval system), to a transport vehicle (e.g. a train or a lorry), or to a production facility.

A conveyor system comprising conveyors is normally employed to transport the storage containers between the port columns 119,120 and the access station.

If the port columns 119,120 and the access station are located at different levels, the conveyor system may comprise a lift device with a vertical component for transporting the storage containers 106 vertically between the port column 119,120 and the access station.

The conveyor system may be arranged to transfer storage containers 106 between different framework structures, e.g. as is described in WO2014/075937A1, the contents of which are incorporated herein by reference.

When a storage container 106 stored in one of the columns 105 disclosed in FIG. 1 is to be accessed, one of the container handling vehicles 201,301,401 is instructed to retrieve the target storage container 106 from its position and transport it to the drop-off port column 119. This operation involves moving the container handling vehicle 201,301,401 to a location above the storage column 105 in which the target storage container 106 is positioned, retrieving the storage container 106 from the storage column 105 using the container handling vehicle's 201,301,401 lifting device (not shown), and transporting the storage container 106 to the drop-off port column 119. If the target storage container 106 is located deep within a stack 107, i.e. with one or a plurality of other storage containers 106 positioned above the target storage container 106, the operation also involves temporarily moving the above-positioned storage containers prior to lifting the target storage container 106 from the storage column 105. This step, which is sometimes referred to as “digging” within the art, may be performed with the same container handling vehicle that is subsequently used for transporting the target storage container to the drop-off port column 119, or with one or a plurality of other cooperating container handling vehicles. Alternatively, or in addition, the automated storage and retrieval system 1 may have container handling vehicles 201,301,401 specifically dedicated to the task of temporarily removing storage containers 106 from a storage column 105. Once the target storage container 106 has been removed from the storage column 105, the temporarily removed storage containers 106 can be repositioned into the original storage column 105. However, the removed storage containers 106 may alternatively be relocated to other storage columns 105.

When a storage container 106 is to be stored in one of the columns 105, one of the container handling vehicles 201,301,401 is instructed to pick up the storage container 106 from the pick-up port column 120 and transport it to a location above the storage column 105 where it is to be stored. After any storage containers 106 positioned at or above the target position within the stack 107 have been removed, the container handling vehicle 201,301,401 positions the storage container 106 at the desired position. The removed storage containers 106 may then be lowered back into the storage column 105, or relocated to other storage columns 105.

For monitoring and controlling the automated storage and retrieval system 1, e.g. monitoring and controlling the location of respective storage containers 106 within the framework structure 100, the content of each storage container 106, and the movement of the container handling vehicles 201,301,401 so that a desired storage container 106 can be delivered to the desired location at the desired time without the container handling vehicles 201,301,401 colliding with each other, the automated storage and retrieval system 1 comprises a control system 500 which typically is computerized and which typically comprises a database for keeping track of the storage containers 106.

WO2017/211596 discloses a storage system comprising a picking and/or supply station. The picking and/or supply station comprises a drawer device, wherein the drawer device comprises a storage container with a compartment for temporarily storing a product item to be picked from or supplied to the storage system. The drawer device is configured to be in a closed state or in an open state; where an person is prevented from accessing the compartment in the closed state and where the person is allowed to access to the compartment in the open state. The picking and/or supply station has a smaller footprint in the closed state than in the open state which can be beneficial e.g. when used on a public environment.

In some applications the user may prefer the drawer being tilted to provide an ergonomic picking position. The drawer device of WO2017/211596 is horizontally oriented in both the open state and the closed state. The drawer device is not configured to be tilted relative the horizontal plane in the open position.

The drawer device of WO2017/211596 is slidably movable between the open state and the closed state. Sliding mechanism such as the drawer device is prone to wear. After picking, either the picker must close the drawer device manually or an additional mechanism must be arranged to close it. Additional mechanism may complicate the device and increase the maintenance requirements.

An aim of the present invention is to provide an access station for an automated storage and retrieval system which alleviates or mitigates at least some of the disadvantages related to the known systems such as ergonomics.

### SUMMARY OF THE INVENTION

The present invention is set forth and characterized in the independent claims, while the dependent claims describe other characteristics of the invention.

The present invention relates to an access station for an automated storage and retrieval system, wherein the access station comprises:
a frame structure; and
a drawer assembly arranged in the frame structure,
wherein the drawer assembly comprises:
   a drawer for accommodating a storage container;
   a lower link pivotally coupled at a first end to the frame structure and pivotally coupled at a second end to the drawer; and
   an upper link pivotally coupled at a first end to the frame structure and pivotally coupled at a second end to the drawer;
wherein the first end of the upper link is arranged above the second end of the upper link, and the first end of the lower link is arranged below the second end of the lower link;
wherein the drawer is movable between a receiving position for receiving a storage container from above, and a picking position for presenting a storage container to a user.

The receiving position may preferably be arranged in an interior of the frame structure.

The drawer preferably has an open top such that a container handling vehicle can lower a storage container through the port column and into the drawer in the receiving position or retrieve a storage container from the drawer in the receiving position via the port column.

A drawer in the receiving position may preferably be inaccessible from an exterior of the frame structure. A user would thus not be able to access the content of the drawer (i.e. a storage container positioned in the drawer) when the drawer is in the receiving position.

The drawer may be urged towards the receiving position such that the drawer returns to the receiving position without aid from a user of the access station (i.e. a picker or consumer). This will allow continued operation of the access station in cases when the user forgets to close the drawer after picking. This is particularly relevant when the user is not trained in using the access station and typically only has one picking to perform.

The picking position may be arranged in front of the receiving position and protruding out from the port column. The picking position may protrude up to roughly a storage container width or storage container length, depending on the orientation of the storage container. However, a storage container placed in the drawer may have partly overlapping positions when in the receiving position and in the picking position. It can thus be achieved an access station with a small footprint, also when opened. The access station will take up a minimum space of its surroundings. It can then be located on a pavement area, in a foyer of a public building or on a public square, without interfering with the pedestrians.

The tilt drawer may be automated.

The access station may comprise one or several sensors in communication with a control system. A sensor may be configured to detect the presence of a storage container in the drawer. The same or another sensor may be configured to detect the position of the drawer.

The access station may comprise an electric motor configured to operate the drawer between the picking position and the receiving position. The electric motor may be controlled by a control system. The control system may receive signals from sensors in the access station or from remotely operated vehicles delivering and retrieving storage containers to/from the access station.

The mechanism for opening and closing the drawer of the drawer assembly (i.e. moving the drawer back and forth between the receiving position and the picking position) may be pivotally coupled or pivotally connected. Advantages of being pivotally coupled/connected is lower friction and less wear on components of the mechanism as compared to a sliding mechanism.

The drawer assembly may comprise two upper links, e.g., in the form of link arms, each being coupled to respective opposite sides of the drawer and respective opposite sides of the frame structure.

In another embodiment, the upper link may be a U-shaped link. The U-shape must be wide enough to allow a storage container to be placed in the drawer, i.e. wider that the width of the storage container or wider than the length of the storage container depending on which way the drawer is configured to receive the storage container.

The upper link, e.g. as a single link arm, as one of two link arms or the U-shaped link, etc., may be pivotally coupled to an outer surface of the drawer and pivotally coupled to an inner surface of the frame structure. The drawer and the frame may therefore be dimensioned to allow the upper link to be arranged and to reciprocate in a space between them or in a space corresponding to a width of an upright member of the frame.

The drawer assembly may comprise two lower links, e.g., in the form of link arms, each being coupled to respective opposite sides of the drawer and respective opposite sides of the frame structure.

The lower link may be pivotally coupled to an outer surface of the drawer and pivotally coupled to an inner surface of the frame structure. The drawer and the frame may therefore be dimensioned to allow the lower link to be arranged and to move into a space between them when the drawer is returned to the receiving position or into a space corresponding to a width of an upright member of the frame.

The drawer assembly may comprise just one upper link and/or just one lower link, wherein upper link and the lower link have different points of contact with the drawer, e.g., the lower link on one side and the upper link on the other side.

The upper link and the lower link may be pivotally coupled to the same surface(s) of the drawer.

The upper link and the lower link may be pivotally coupled to the same surface(s) of the frame structure.

The upper link should be positioned such that the drawer can receive a storage container from above when it is in the receiving position, i.e. the upper link should not obstruct a storage container being placed in the drawer or retrieved from the drawer when the drawer is in the receiving position.

The lower link will not obstruct a storage container being placed in the drawer or retrieved from the drawer when the drawer is in the receiving position. The lower link can therefore be placed irrespective of the placing/retrieving of the storage container. The lower link may e.g. be positioned on the left side, the right side, both sides, or in the middle.

The lower link may be configured to provide a barrier to entry to the port column, e.g. by comprising a plate, panel, grille or other barrier structure arranged between two link arm portions. The plate, panel, grille or other barrier structure may e.g. be made from sheet metal or moulded/formed from plastics.

In one embodiment, the frame structure comprises a plate forming a front cover of the access station. A pair of lower link arm portions may be stowed in slots in the frame structure or pulled back flush with to the front of the access station as the drawer moves to the receiving position.

The drawer assembly may be configured to separate the interior of the access station from the exterior of the access station when the drawer is located in the receiving position. The gaps between the lower link, the drawer and the frame structure can preferably be sufficiently small for hands/fingers not to fit between them when the drawer is in the receiving position. By physically separating the interior of the access station from the exterior of the access station, the risk of injury can be reduced for the user of the access station.

The second end of the upper link and the second end of the lower link are preferably spaced apart in the horizontal direction X, in the vertical direction Y, or in both the horizontal direction and the vertical direction.

The second end of the upper link is preferably coupled to a rear part of the drawer, i.e. a part of the drawer closest to a storage section of the automated storage and retrieval system.

The second end of the lower link is preferably coupled to a front part of the drawer, opposite the rear part of the drawer, i.e. a part of the drawer closest to a position where the user will typically be.

The second end of the upper link may be coupled to a mid-height part of the drawer or an upper part of the drawer. The second end of the upper link is preferably coupled to a lower part of the drawer.

The second end of the lower link may be coupled to a mid-height part of the drawer or an upper part of the drawer. The second end of the lower link is preferably coupled to a lower part of the drawer.

The first end of the upper link may not be arranged directly above the first end of the lower link, i.e. spaced apart in a first direction X by a distance D_{A}.

When the drawer is in the receiving position, the second end of the upper link may be horizontally levelled with the second end of the lower link. The second end of the upper link and the second end of the lower link are preferably spaced apart in the first direction X by a distance D_{B}.

The drawer has a support on which the storage container can be placed. This might be an upwardly facing surface of a base of the drawer, for example, or a set of formations on which the storage container rests within the drawer, e.g., supporting a rim of the storage container in the drawer. When the drawer is in the receiving position, the support of the drawer is preferably horizontal. When the drawer is in the picking position, the support of the drawer is preferably tilted relative the horizontal plane by a drawer tilt angle α_{B}.

The drawer tilt angle α_{B} may range from 5° to 45° relative to a horizontal plane P_{H}, more preferably from 10° to 40°, even more preferably from 15° to 35°, even more preferably from 20° to 30°, for example 25°.

A preferred tilt angle range is 20° to 30°. This tilt angle range may, however, have a starting point of 5°, 10°, 15°, 20°, 25°. This tilt angle range may have an end point of 25°, 30°, 35°, 40°, 45°.

The drawer follows a set path (i.e. a drawer path) as it moves between the receiving position and the picking position. This path and the drawer tilt angle may be selected with parameters such as:
the horizontal distance between the first end of the lower link and the first end of the upper link D_{A},
the horizontal distance between the second end of the lower link and the second end of the upper link D_{B},
the length L_{U} of the upper link, and
the length L_{L} of the lower link.

The point on the frame structure to which the first end of the upper link is coupled (i.e. an upper link first coupling point) is typically fixed.

The point on the drawer to which the second end of the upper link is coupled (i.e. an upper link second coupling point) follows a path (i.e. an upper link path) between the receiving position and the picking position. The upper link path is defined by an arc when the upper link first coupling point is fixed. The relative height of the upper link second coupling point with respect to the frame structure thus change along the upper link path.

The point on the frame structure to which the first end of the lower link is coupled (i.e. a lower link first coupling point) is typically fixed.

The point on the drawer to which the second end of the lower link is coupled (i.e. a lower link second coupling point) follows a path (i.e. a lower link path) between the receiving position and the picking position. The lower link path is defined by an arc when the lower link first coupling point is fixed. The relative height of the lower link second coupling point with respect to the frame structure thus changes along the lower link path.

The combination of the upper link path and the lower link path defines the drawer path.

The arc defining the upper link path has a radius equal the length of the upper link. It follows that a longer upper link provides a greater radius and a shorter upper link provides a smaller radius. The distance between the upper link second coupling point when in the receiving position and when in the picking position can therefore never be greater than 2× the length of the upper link.

Thus, the length of the upper link should preferably be at least 50% of a length of a side of the drawer.

The arc defining the lower link path has a radius equal the length of the lower link. It follows that a longer lower link provides a grater radius and a shorter lower link provides a smaller radius. The distance between the lower link second coupling point when in the receiving position and when in the picking position can therefore never be greater than 2× the length of the lower link.

Thus, the length of the lower link should preferably be at least 50% of the length of a side of the drawer.

In the receiving position, the first end of the upper link and the second end of the upper link may be arranged with a horizontal distance D_{UR}, such that the second end of the upper link moves toward vertical alignment with the first end of the upper link as the drawer moves out of the receiving position, then the second end of the upper link will initially move downward.

In the picking position, the first end of the upper link and the second end of the upper link may be arranged with a horizontal distance D_{UP}, such that the second end of the upper link moves toward vertical alignment with the first end of the upper link as the drawer moves out of the picking position, then the second end of the upper link will initially move downward.

The second end of the upper link will move downward when it moves toward vertical alignment with the first end of the upper link. And the second end of the upper link will move upward when it moves away from vertical alignment with the first end of the upper link.

The second end of the upper link will reach its lowest possible point when it is vertically aligned with the first end of the upper link.

If the horizontal distance between the first end of the upper link and the second end of the upper link are equal for the picking position and the receiving position (D_{UP}=D_{UR}), then the relative height of the upper link second coupling point with respect to the frame structure is the same in both positions.

In the receiving position, the first end of the lower link and the second end of the lower link may be arranged with a horizontal distance D_{LR}, such that the second end of the lower link moves toward vertical alignment with the first end of the lower link as the drawer moves out of the receiving position, resulting in the second end of the lower link initially moving upward.

In the picking position, the first end of the lower link and the second end of the lower link may be arranged with a horizontal distance D_{LP}, such that the second end of the lower link moves toward vertical alignment with the first end of the lower link as the drawer moves out of the picking position, resulting in the second end of the lower link initially moving upward.

In one embodiment, the second end of the lower link will move upward when it moves toward vertical alignment with the first end of the lower link, and the second end of the lower link will move downward when it moves away from vertical alignment with the first end of the lower link.

The second end of the lower link will reach its highest possible point when it is vertically aligned with the first end of the lower link.

If the horizontal distance between the first end of the lower link and the second end of the lower link are equal for the picking position and the receiving position (D_{LP}=D_{LR}), then the relative height of the lower link second coupling point with respect to the frame structure is the same in both positions.

The closer D_{LP} is to D_{LR}, the less variation there will be in the relative height of the lower link second coupling point with respect to the frame structure.

The greater difference between the values D_{LP} and D_{LR}, the more variation there will be in the relative height of the lower link second coupling point with respect to the frame structure.

The closer D_{UP} is to D_{UR}, the less variation there will be in the relative height of the upper link second coupling point with respect to the frame structure. The greater difference between the values D_{UP} and D_{UR}, the more variation there will be in the relative height of the upper link second coupling point with respect to the frame structure.

The closer to vertical the upper link is oriented during the upper link path (i.e. the smaller α_{UP} and α_{UR}), the less variation there will be in the relative height of the upper link second coupling point with respect to the frame structure.

The closer to horizontal the upper link is oriented during the upper link path (i.e. the greater α_{UP} and α_{UR}), the more variation there will be in the relative height of the upper link second coupling point with respect to the frame structure.

From the vertical orientation, a longer upper link has a smaller vertical component as compared to a shorter upper link when the two lengths of upper link are to provide the same horizontal displacement.

The length of the upper link may be seen as the distance between the first end of the upper link and the second end of the upper link, or as the distance between the upper link first coupling point and the upper link second coupling point.

The closer to vertical the lower link is oriented along the lower link path (i.e. the smaller α_{LP} and α_{LR}), the less variation there will be in the relative height of the lower link second coupling point with respect to the frame structure.

The closer to horizontal the lower link is oriented along the lower link path (i.e. the greater α_{LP} and α_{LR}), the more variation there will be in the relative height of the lower link second coupling point with respect to the frame structure.

From the vertical orientation, a longer lower link has a smaller vertical component as compared to a shorter lower link when the two lengths of lower link are to provide the same horizontal displacement.

The length of the lower link may be seen as the distance between the first end of the lower link and the second end of the lower link, or as the distance between the lower link first coupling point and the lower link second coupling point.

The basis for the drawer path should be that the drawer is horizontally oriented in the receiving position, i.e. configured to receive a storage container from above.

The drawer path is set by combining the upper link path and the lower link path that provides the desired drawer tilt angle in the picking position. Generally, an upper link path and a lower link path having substantially the same variations in the relative height of the upper/lower link second coupling point relative the frame structure will result in a smaller drawer tilting angle. Whereas an upper link path and a lower link path having greater differences in their variation in relative height of the upper/lower link second coupling point relative the frame structure will result in a greater drawer tilting angle. The drawer tilting angle may be further increased by reducing the horizontal distance D_{B} between the second end of the lower link (i.e. the lower link second coupling point) and the second end of the upper link (i.e. the upper link second coupling point).

In the picking position, the drawer may have a tilt angle α_{B} relative the horizontal plane, the upper link has a pivot angle α_{UP} relative the vertical plane, and the lower link has a pivot angle α_{LP} relative the vertical plane. An advantage of the access station is that the drawer tilt angle can be less than the upper link pivot angle and the lower link pivot angle.

The drawer will typically be box-shaped and have an open top. The drawer may have solid sides or robust grille sides. The drawer can be made of metal or other materials making it sturdy and durable.

The drawer may have a handle for a user of the access station to operate the drawer between the receiving position and the picking position.

The drawer may be configured to close off the front of the access station, i.e. the side of the access station facing the user, when the drawer is in the receiving position.

The drawer will typically be configured to receive one storage container, however, in one embodiment the drawer may be configures to receive two or more storage containers, e.g. side-by-side.

In one aspect, the first end of the upper link may be arranged above the drawer and the first end of the lower link is arranged below the drawer.

In one aspect, the lower link may have a lower link length and the upper link has an upper link length,
wherein the ratio between the lower link length and the upper link length is in the range 1:1-1:2.

In one aspect, the drawer may be suspended by only the upper link and the lower link.

The frame structure may provide some guidance in the second direction Y without being coupled to the drawer.

The upper link and the lower link may follow the movement of the drawer as it moves back and forth between the receiving position and the picking position. The drawer will typically be suspended in an approximately horizontal position (e.g., ±10° about true horizontal) during the drawer's range of movement.

The upper link and the lower link may be directly coupled to the drawer. Alternatively, the upper link and the lower link may be indirectly coupled to the drawer, e.g. via one or more intermediate components such as another link.

In one aspect, the drawer is level in the receiving position.

In one aspect, the first end of the upper link and the second end of the upper link may be vertically aligned when the drawer is in a position between the picking position and the receiving position.

The drawer assembly may be configured such that the first end of the lower link and the second end of the lower link are vertically aligned when the drawer is in a position between the picking position and the receiving position.

The drawer assembly is preferably configured such that the first end of the lower link and the second end of the lower link are not vertically aligned when the drawer is in a position where the first end of the upper link and the second end of the upper link are vertically aligned.

The drawer assembly may be configured such that the first end of the upper link and the second end of the upper link are never vertically aligned when the drawer is in a position between the picking position and the receiving position.

In one aspect, the frame structure may have a frontside and a backside,
wherein when the drawer is in the receiving position, the second end of the lower link is closer to the backside of the frame structure than the first end of the lower link.

The drawer will then be configured to stay in the receiving position until it is pulled out of this position by a user or by means of an actuator.

The drawer will then also be urged towards the receiving position when the drawer is located between the receiving position and a position where the first end of the lower link and the second end of the lower link are vertically aligned.

The drawer assembly may be configured such that the first end of the lower link and the second end of the lower link are never vertically aligned when the drawer is in a position between the picking position and the receiving position.

The backside of the frame structure will typically face a storage section when the access station is arranged in an automated storage and retrieval system.

The backside of the frame structure is opposite the frontside of the frame structure. The frontside of the frame structure will typically face a user of the access station.

The lower link first coupling point may be arranged flush with the frontside of the frame structure.

The upper link first coupling point may be arranged between the frontside of the frame structure and a backside of the frame structure.

In one aspect, the frame structure may have a frontside and a backside,
wherein when the drawer is in the picking position, the first end of the lower link is closer to the backside of the frame structure than the second end of the lower link.

The drawer will then be configured to stay in the picking position until it is pushed out of this position by a user or by means of an actuator.

The drawer will then also be urged towards the picking position when the drawer is located between the picking position and a position where the first end of the lower link and the second end of the lower link are vertically aligned.

In one aspect, the access station may be configured for vertical alignment of the receiving position with a port column of the automated storage and retrieval system for receiving storage containers therefrom.

An upper part of the frame structure may form part of a port column vertically aligned with the receiving position.

A container handling vehicle may then lower a storage container through the port column and into the drawer in the receiving position or retrieve a storage container from the drawer in the receiving position via the port column.

In one aspect, the frame structure and/or the drawer assembly may be configured to prevent retrieval of a storage container from the drawer when the drawer is in the picking position.

This will prevent vandals from stealing storage containers from the system when the access station is located on a pavement area.

Preventing retrieval of a storage container from the drawer when the drawer is in the picking position can be achieved by partly obstructing an opening of the drawer by components of the drawer assembly or with the frame structure. The obstruction should allow the user to access the content of a storage container placed in the drawer, while preventing retrieval of the same storage container because the storage container has an area larger than the unobstructed area of the drawer.

This may be achieved by means of the drawer assembly comprising a tilt limiter, by means of a tilt limiter arranged on the frame structure, or by means of a portion of the frame structure providing a tilt limiter, e.g., a cross-member of the frame. The tilt limiter being configured to limit movement of the drawer beyond the picking position.

The tilt limiter may be configured to cause engagement between the drawer and the frame structure at a predetermined point of the movement, such that further movement is prevented. The predetermined point of the movement will typically be the picking position.

The tilt limiter may be arranged on the drawer and configured to extend upwardly relative to the drawer. The tilt limiter may be a separate item connected to the drawer or be made part of (i.e. integral with) the drawer.

The tilt limiter is preferably configured to not obstruct the alignment of the drawer with a column of the frame structure when the drawer is located in the receiving position.

A blocker may be configured to be located between two upright members of the frame structure when the drawer is located in the receiving position. The tilt limiter may additionally serve this purpose if located in the upper part of the drawer. The blocker may prevent movement of the gripping device close to the drawer when the drawer is not in the receiving position.

One access station may also comprise a plurality of drawer assemblies arranged side-by-side in the frame structure. In this way a plurality of users may be able to access items simultaneously.

The present invention also relates to an automated storage and retrieval system, wherein the automated storage and retrieval system comprises:
an access station as described herein;
a rail system comprising a first set of parallel rails arranged in a horizontal plane and extending in a first direction and a second set of parallel rails arranged in the horizontal plane and extending in a second direction which is orthogonal to the first direction, which first and second sets of rails form a grid in the horizontal plane comprising a plurality of adjacent access openings;
a storage section comprising a plurality of storage containers arranged in storage columns located beneath the rail system,
wherein each storage column is located vertically below one of the plurality of access openings;
at least one port column located beneath the rail system and vertically aligned with a receiving position of the access station, the at least one port column being void of stored storage containers; and
a container handling vehicle comprising a gripping device for lifting storage containers stored in the columns above the storage section and drive means configured to drive the vehicle along the rail system in at least one of the first direction and the second direction.

The drawer will generally correspond to an area in plan of about one access opening of the rail system.

In one aspect, the access station may be configured to provide a lower section of the port column.

In one aspect, the automated storage and retrieval system may comprise at least two access stations, preferably three or four access stations.

The present invention also relates to a method of presenting a storage container at an access station using an automated storage and retrieval system as described herein,
wherein the method comprises the steps of:
   retrieving a storage container stored in a storage section of the storage and retrieval system by means of a container handling vehicle comprising a gripping device;
   moving a drawer of the access station to a receiving position;
   placing the storage container in a drawer of the drawer assembly; and
   moving the drawer into a picking position to present the storage container to a user.

In one aspect, the method may, after presenting the storage container to the user, comprise the steps of:
returning the drawer to the receiving position; and
retrieving the storage container from the drawer.

### BRIEF DESCRIPTION OF THE DRAWINGS

Following drawings are appended to facilitate the understanding of the invention. The drawings show embodiments of the invention, which will now be described by way of example only, where:

FIG. 1 is a perspective view of a framework structure of a prior art automated storage and retrieval system.

FIG. 2 is a perspective view of a prior art container handling vehicle having an internally arranged cavity for carrying storage containers therein.

FIG. 3 is a perspective view of a prior art container handling vehicle having a cantilever for carrying storage containers underneath.

FIG. 4 is a perspective view, seen from below, of a prior art container handling vehicle having an internally arranged cavity for carrying storage containers therein.

FIG. 5 is a perspective view of a storage container and product items stored in the storage container.

FIG. 6a is a perspective view of an access station for an automated storage and retrieval system. The access station comprises a frame structure and a drawer assembly, wherein a drawer of the drawer assembly is located in the receiving position.

FIG. 6b is a perspective view of the access station of FIG. 6a wherein the drawer is located between the receiving position and the picking position.

FIG. 6c is a perspective view of the access station of FIG. 6a wherein the drawer is located in the picking position.

FIG. 7a is a horizontal cross-section of the access station of FIG. 6a wherein the drawer is located in the receiving position. In addition to the drawer, the drawer assembly comprises an upper link and a lower link suspending the drawer in the frame structure.

FIG. 7b is a horizontal cross-section of the access station of FIG. 7a wherein the drawer is located between the receiving position and the picking position.

FIG. 7c is a horizontal cross-section of the access station of FIG. 7a wherein the drawer is located in the picking position.

FIG. 8a is a perspective view of the access station. The access station comprises a frame structure and a drawer assembly, wherein a drawer of the drawer assembly is located in the receiving position.

FIG. 8b is a perspective view of the access station of FIG. 8a wherein the drawer is located between the receiving position and the picking position.

FIG. 8c is a perspective view of the access station of FIG. 8a wherein the drawer is located in the picking position.

FIG. 9a is a horizontal cross-section of the access station of FIG. 8a wherein the drawer is located in the receiving position. In addition to the drawer, the drawer assembly comprises an upper link and a lower link suspending the drawer in the frame structure.

FIG. 9b is a horizontal cross-section of the access station of FIG. 9a wherein the drawer is located between the receiving position and the picking position.

FIG. 9c is a horizontal cross-section of the access station of FIG. 9a wherein the drawer is located in the picking position.

FIG. 10a is a top view of a portion of an automated storage and retrieval system comprising a plurality of access stations, wherein the drawers are in the receiving positions and the receiving positions are vertically aligned with access openings of an above rail system.

FIG. 10b is a top view of the portion of the automated storage and retrieval system of FIG. 14a, wherein the drawers are in the picking positions.

### DETAILED DESCRIPTION OF THE INVENTION

In the following, embodiments of the invention will be discussed in more detail with reference to the appended drawings. It should be understood, however, that the drawings are not intended to limit the invention to the subject-matter depicted in the drawings.

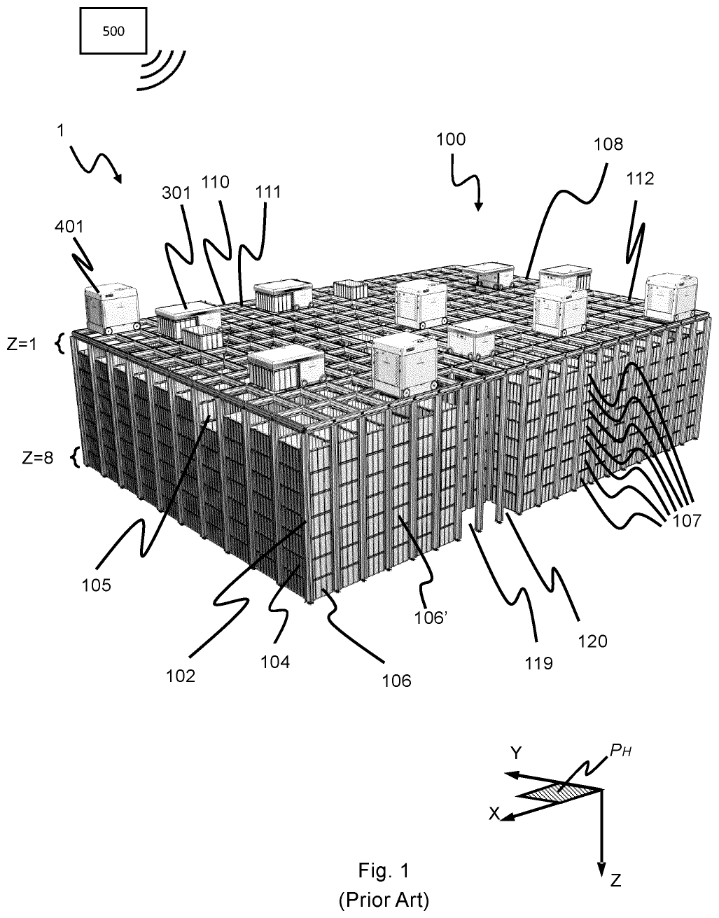

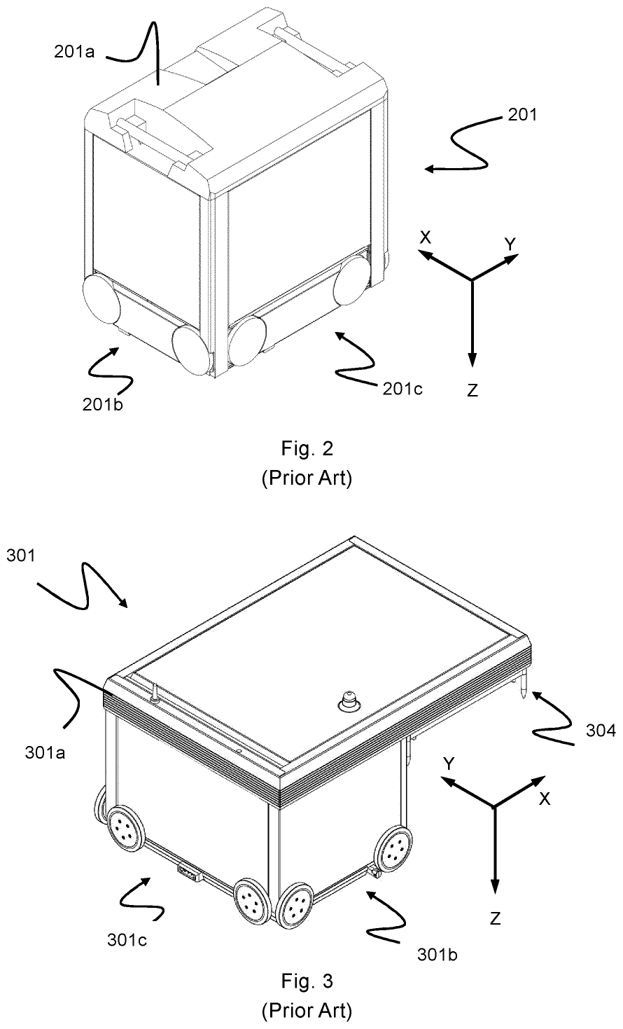

The framework structure 100 of the automated storage and retrieval system 1 is constructed in a similar manner to the prior art framework structure 100 described above in connection with FIGS. 1-3. That is, the framework structure 100 comprises a number of upright members 102, and comprises a first, upper rail system 108 extending in the X direction and Y direction.

The framework structure 100 further comprises storage compartments in the form of storage columns 105 provided between the members 102 wherein storage containers 106 are stackable in stacks 107 within the storage columns 105.

The framework structure 100 can be of any size. In particular it is understood that the framework structure can be considerably wider and/or longer and/or deeper than disclosed in FIG. 1. For example, the framework structure 100 may have a horizontal extent of more than 700×700 columns and a storage depth of more than twelve containers.

One embodiment of the automated storage and retrieval system according to the invention will now be discussed in more detail with reference to Figs.

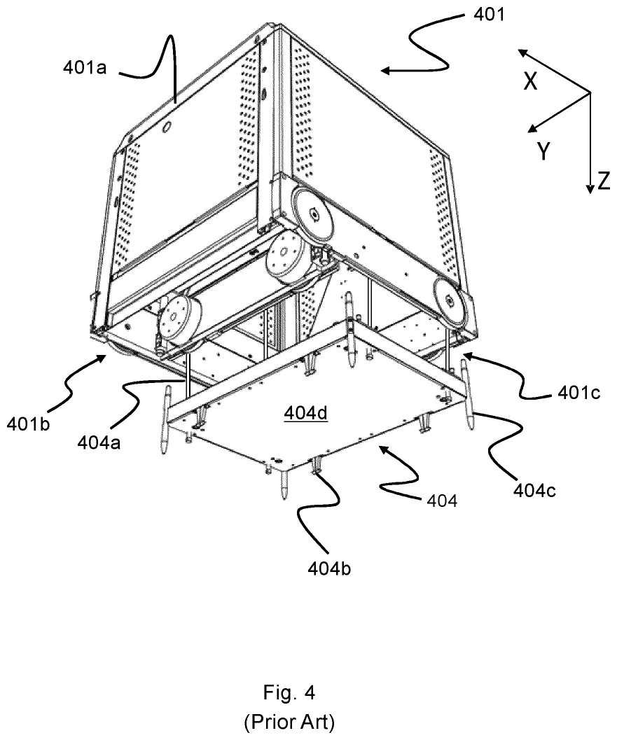

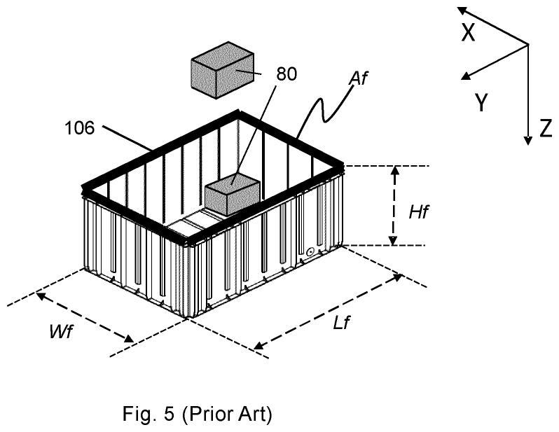

FIG. 5 shows examples of product items 80 stored in a storage container 106. The storage container 106 illustrated in FIG. 4 has a height Hƒ, a width Wƒ and a length Lƒ. The storage container 106 has a horizontal cross section Aƒ.

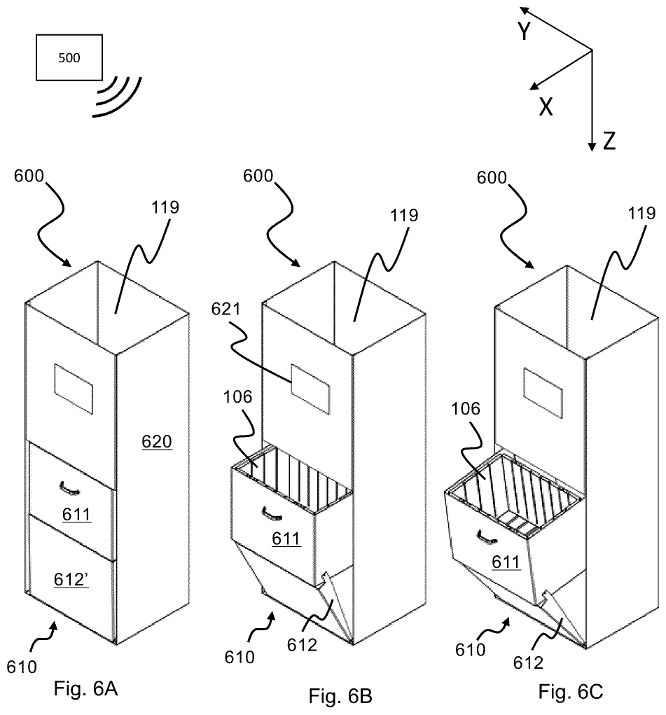

FIGS. 6a-c show perspective views of an access station 600 for an automated storage and retrieval system 1. The access station 600 comprises a frame structure 620 and a drawer assembly 610 arranged in the frame structure 620. The drawer assembly 610 comprises a drawer 611 for accommodating a storage container 106.

This series of figures show an operational sequence wherein the drawer 611 is moved from a receiving position P_{R} in FIG. 6a to a picking position P_{P} in FIG. 6c.

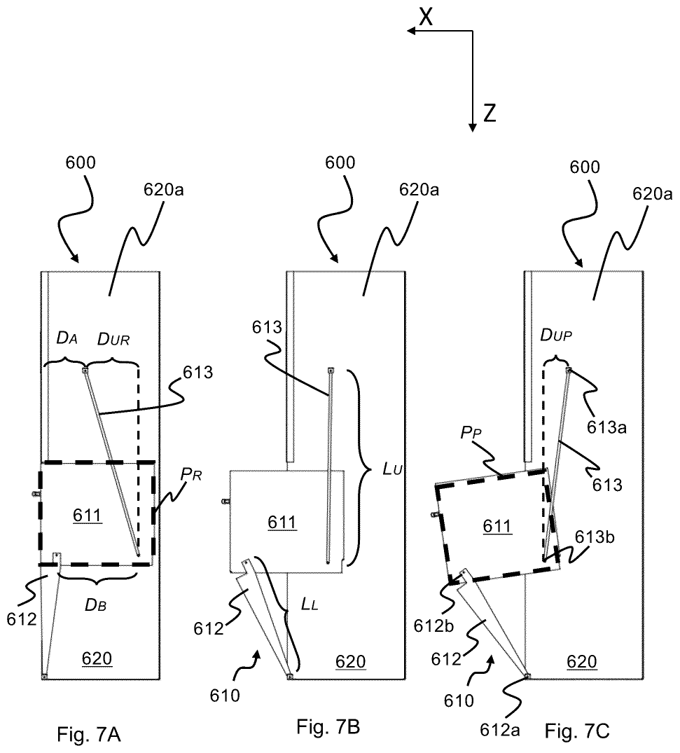

FIGS. 7a-c show horizontal cross-sections of the access station 600 as shown in FIGS. 6a-c respectively.

In addition to the drawer 611, the drawer assembly 610 comprises a lower link 612 pivotally coupled at a first end 612a to the frame structure 620 and pivotally coupled at a second end 612b to the drawer 611. The drawer assembly 610 also comprises an upper link 613 pivotally coupled at a first end 613a to the frame structure 620 and pivotally coupled at a second end 613b to the drawer 611.

The first end 613a of the upper link 613 is arranged above the second end 613b of the upper link 613, and the first end 612a of the lower link 612 is arranged below the second end 612b of the lower link 612, regardless of the position of the drawer 611.

The upper link 613 and the lower link 612 allow the drawer 611 to move between a receiving position P_{R} for receiving a storage container 106 from above, and a picking position P_{P} for presenting a storage container 106 to a user of the access station 600.

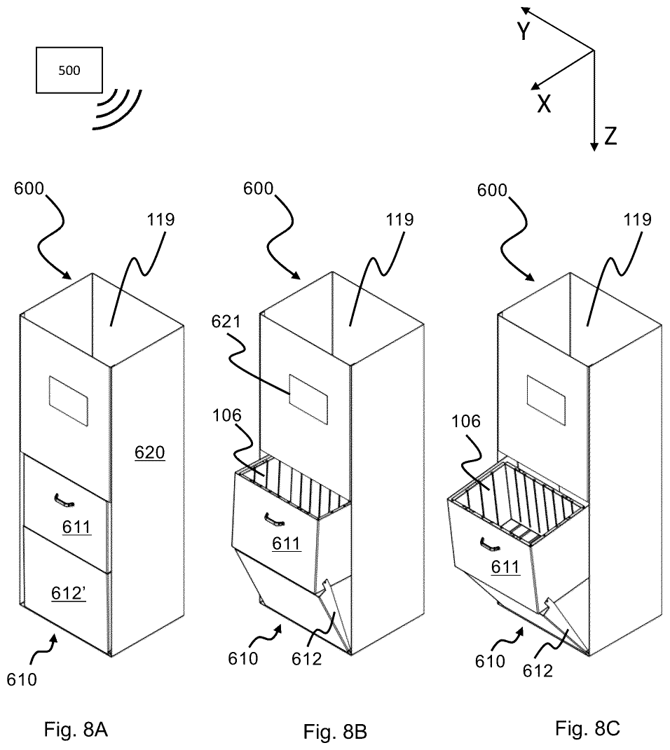

FIGS. 8a-c show perspective views of an access station 600 of the same type as the access station 600 in FIGS. 6a-c. The two access stations 600 may be used interchangeably for the same purpose. The two access stations 600 will comprise the same components wherein the components may have different configurations.

The access station 600 shown in FIGS. 8a-c provides a picking position P_{P} with a different drawer tilt angle α_{b} than the access station 600 shown in FIGS. 6a-c.

FIGS. 8a-c also show an operational sequence wherein the drawer 611 is moved from a receiving position P_{R} in FIG. 8a to a picking position P_{P} in FIG. 8c.

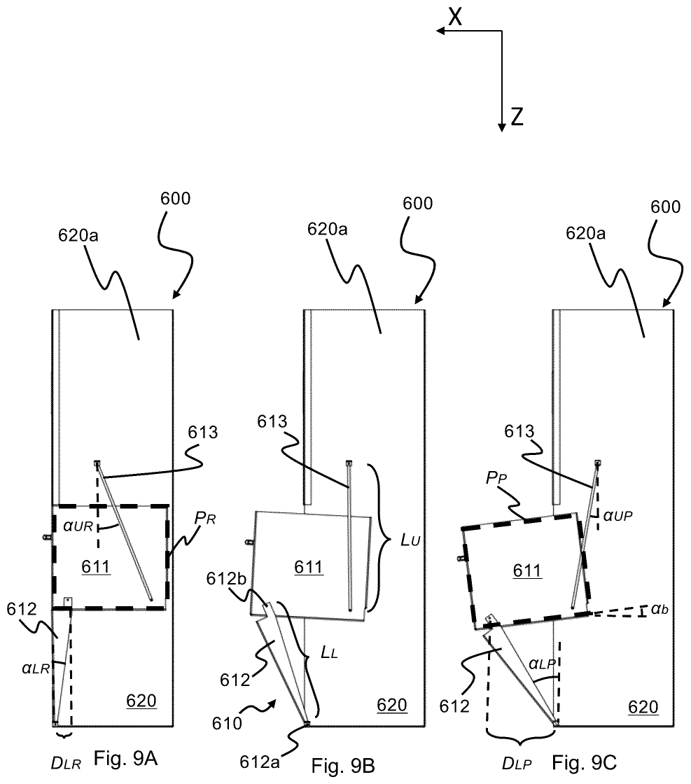

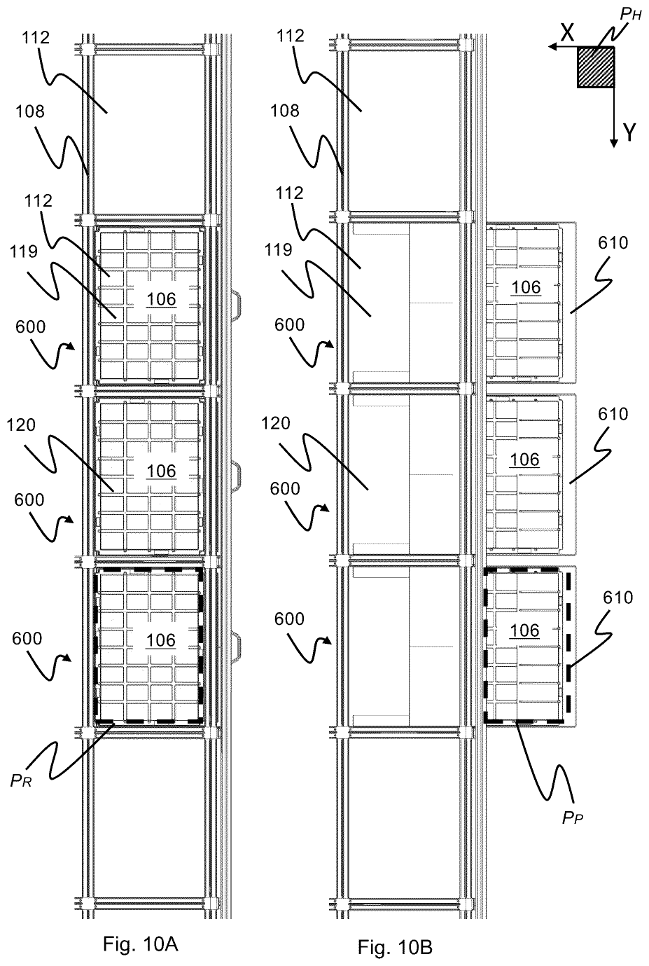

FIGS. 9a-c show horizontal cross-sections of the access station 600 as shown in FIGS. 8a-c respectively.

The first end 613a of the upper link 613 will typically be arranged above the drawer 611 and the first end 612a of the lower link 612 will typically be arranged below the drawer 611. In the exemplifying figures, both the second 612b end of the lower link 612 and the second end 613b of the upper link 613 are coupled to a lower part of the drawer 611. The lower link 612 then has a lower link length L_{L} that is greater than the vertical extent of the drawer 611. The upper link 612 may have an upper link length L_{U} that is greater than the vertical extent of the drawer 611, e.g. equal to the lower link length L_{L}, but does not have to.

The ratio between the lower link length L_{L} and the upper link length L_{U} may be in the range 1:1-1:2. FIGS. 9a-c show an example where the ratio is approximately 1:1.

In FIGS. 7a-c and FIGS. 9a-c, the drawer 611 is suspended by only the upper link 613 and the lower link 612. However, the frame structure 620 may still provide some guidance in the second direction Y, i.e. orthogonal to the first direction X in which the drawer 611 moves between the receiving position P_{R} and the picking position P_{P}.

In both the examples shown in FIG. 7a and FIG. 9a, the drawer 611 is level in the receiving position P_{R}. The drawer 611 should be level in this position in order to receive a storage container 106 from above without jamming.

The upper link 613 and the lower link 612 can be considered oppositely oriented pendulums as they are both fix at one end, i.e. their first ends 612a,613a. These can be referred to as the upper link first coupling point and the lower link first coupling point. These coupling points allow the upper link 613 and the lower link 612 to pivot but are not movable in the vertical or horizontal directions X,Y,Z relative the frame structure.

The second end 163b of the upper link 613 and the second end 612b of the lower link 612 are movable in the horizontal and vertical direction X,Z and follow an arc shaped path. The arc shaped paths are dictated by the lower link length L_{L} and the upper link length L_{U}.

In FIG. 7a and FIG. 9a, the drawer 611 is in the receiving position P_{R} and there is a distance D_{UR} between the first end 613a of the upper link 613 and the second end 613b of the upper link 613. The upper link 613 then has an upper link pivot angle α_{UR} relative to vertical. The second end 613b of the upper link 613 is then closer to a backside of the frame structure 620 than the first end 613a of the upper link 613.

As the drawer 611 is moved closer to the picking position P_{P} as illustrated in FIG. 7b and FIG. 9b, the second end 613b of the upper link 613 has moved both a horizontal distance forward and a vertical distance downward. The first end 613a of the upper link 613 and the second end 613b of the upper link 613 are approximately vertically aligned and the second end 613b is therefore at its lowest possible point.

In FIG. 7c and FIG. 9c, the drawer 611 is in the picking position P_{P} and there is a distance D_{UP} between the first end 613a of the upper link 613 and the second end 613b of the upper link 613. The upper link 613 then has an upper link pivot angle α_{UP} relative to vertical. The first end 613a of the upper link 613 is then closer to the backside of the frame structure 620 than the second end 613b of the upper link 613. The second end 613b of the upper link 613 has moved a further horizontal distance forward and a vertical distance upward.

If the upper link 613 is arranged such that the pivot angles α_{UP} and α_{UR} are equal, the second end 613b of the upper link 613 will be at the same relative height with respect to the frame structure 620 in both the receiving position P_{R} and the picking position P_{P}.

By arranging the upper link 613 such that the difference between the pivot angles α_{UP} and α_{UR} is increased, the second end 613b of the upper link 613 will have a greater difference in its relative height with respect to the frame structure 620 in the receiving position P_{R} and the picking position P_{P}. This effect can be reduced by increasing the length L_{U} of the upper link 613. This can be relevant in cases where it is desired to have the second end 613b of the upper link 613 at substantially the same relative height with respect to the frame structure 620 in both the receiving position P_{R} and the picking position P_{P} but it is not possible to arrange the drawer assembly such that the pivot angles α_{LP} and α_{LR} are equal.

The difference in the relative height of the second end 613b of the upper link 613 with respect to the frame structure 620 can be further increased by arranging the upper link 613 such that the first end 613a of the upper link 613 and the second end 613b of the upper link 613 are never vertically aligned during the drawer's 611 movement between the receiving position P_{R} and the picking position P_{P}.

In FIG. 7a and FIG. 9a, the drawer 611 is in the receiving position P_{R} and there is a distance D_{LR} between the first end 612a of the lower link 612 and the second end 612b of the lower link 612. The lower link 612 then has a lower link pivot angle α_{LR} relative to vertical. The second end 612b of the lower link 612 is then closer to a backside of the frame structure 620 than the first end 612a of the lower link 612.

As the drawer 611 is moved closer to the picking position P_{P} as illustrated in FIG. 7b and FIG. 9b, the second end 612b of the lower link 612 has moved both a horizontal distance forward and a vertical distance initially upward and later downward. When the first end 612a of the lower link 612 and the second end 612b of the lower link 612 are vertically aligned, the second end 612b will be at its highest possible point.

In FIG. 7c and FIG. 9c, the drawer 611 is in the picking position P_{P} and there is a distance D_{LP} between the first end 612a of the lower link 612 and the second end 612b of the lower link 612. The lower link 612 then has a lower link pivot angle α_{LP} relative to vertical. The first end 612a of the lower link 612 is then closer to the backside of the frame structure 620 than the second end 612b of the lower link 612. The second end 612b of the lower link 612 has moved a further horizontal distance forward and a vertical distance downward.

If the lower link 612 is arranged such that the pivot angles α_{LP} and α_{LR} are equal, the second end 612b of the upper link 612 will be at the same relative height with respect to the frame structure 620 in both the receiving position P_{R} and the picking position P_{P}.

By arranging the lower link 612 such that the difference between the pivot angles α_{LP} and α_{LR} is increased, the second end 612b of the upper link 612 will have a greater difference in its relative height with respect to the frame structure 620 in the receiving position P_{R} and the picking position P_{P}. This effect can be reduced by increasing the length of the lower link 612. This can be relevant in cases where it is desired to have the second end 612b of the lower link 612 at substantially the same relative height with respect to the frame structure 620 in both the receiving position P_{R} and the picking position P_{P} but it is not possible to arrange the drawer assembly such that the pivot angles α_{LP} and α_{LR} are equal.

The difference in the relative height of the second end 612b of the lower link 612 with respect to the frame structure 620 can be further increased by arranging the lower link 612 such that the first end 612a of the lower link 612 and the second end 612b of the lower link 612 are never vertically aligned during the drawer's 611 movement between the receiving position P_{R} and the picking position P_{P}.

When the drawer 611 is in the picking position P_{P} it may preferably have a drawer tilt angle α_{B}. The picking position P_{P} can then be tilted and thus be made more ergonomic for the user of the access station 600 as easier access to the content of the drawer can be provided.

The drawer tilt angle α_{B} can be set by means of the configuration of the lower link 612 and the upper link 613.

The drawer tilt angle α_{B} can be minimized by configuring the upper link 613 and the lower link 612 such that the second end 613b of the upper link 613 and the second end 612b of the lower link 612 have substantially the same change in their relative height with respect to the frame structure 620 between the receiving position P_{R} and the picking position P_{P}. Both the second end 613b of the upper link 613 and the second end 612b of the lower link 612 may have a significant change in the relative height with respect to the frame structure 620 between the receiving position P_{R} and the picking position P_{P}, as long as both have substantially the same change.

The drawer tilt angle α_{B} can be increased by configuring the upper link 613 such that the second end 613b of the upper link 613 has a height with respect to the frame structure 620 that is lower in the receiving position P_{R} than in the picking position P_{P}. The greater this difference is, the more can the drawer tilt angle α_{B} be increased.

The drawer tilt angle α_{B} can be increased by configuring the lower link 612 such that the second end 612b of the lower link 612 has a height with respect to the frame structure 620 that is higher in the receiving position P_{R} than in the picking position P_{P}. The greater this difference is, the more can the drawer tilt angle α_{B} be increased.

This effect on the drawer tilt angle α_{B} can be further increased by reducing the horizontal distance D_{B} between the second end 612b of the lower link 612 and the second end 613b of the upper link 613.

The drawer 611 may be urged towards the receiving position P_{R}. In FIG. 7a and FIG. 9a, the lower link 612 is arranged such that the second end 612b of the lower link 612 initially must travel partly upward (and partly forward) as it moves out of the receiving position P_{R}. This is because the first end 612a of the lower link 612 is arranged below the second end 612b of the lower link 612, and the second end 612b of the lower link 612 is closer to the backside of the frame structure 620 than the first end 612a of the lower link 612. The drawer 611 and its content will be urged downward by gravity. The resulting force will thus work against the drawer 611 being moved partly upward and out of the receiving position P_{R}. This effect may be increased by a heavier drawer 611. The drawer 611 may be urged towards the receiving position P_{R} as long as the second end 612b of the lower link 612 is closer to the back of the frame structure 620 than the first end 612a of the lower link 612.

The drawer 611 may be urged towards the picking position P_{P}. In FIG. 7c and FIG. 9c, the lower link 612 is arranged such that the second end 612b of the lower link 612 initially must travel partly upward (and partly backward) as it moves out of the picking position P_{P}. This is because the first end 612a of the lower link 612 is arranged below the second end 612b of the lower link 612, and the first end 612a of the lower link 612 is closer to the backside of the frame structure 620 than the second end 612b of the lower link 612. The drawer 611 and its content will be urged downward by gravity. The resulting force will thus work against the drawer 611 being moved partly upward and out of the picking position P_{P}. This effect may be increased by a heavier drawer 611. The drawer 611 may be urged towards the picking position P_{P} as long as the first end 612a of the lower link 612 is closer to the back of the frame structure 620 than the second end 612b of the lower link 612.

When the first end 612a of the lower link 612 and the second end 612b of the lower link 612 are vertically aligned, the two are equally close to the backside of the frame structure 620. In that position, the drawer 611 may not be urged towards neither the receiving position P_{R} nor the picking position P_{P}. However, depending on where the lower link second coupling point is arranged on the drawer 611, the drawer 611 may also be urged to either the receiving position P_{R} or the picking position P_{P} also when the first end 612a of the lower link 612 and the second end 612b of the lower link 612 are vertically aligned. Arranging the lower link second coupling point closer to the frontside of the drawer 611 may facilitate the drawer 611 being urged towards the receiving position P_{R} rather than the picking position P_{P}. Arranging the lower link second coupling point closer to the backside of the drawer 611 may facilitate the drawer 611 being urged towards the picking position P_{P} rather than the receiving position P_{R}.

FIG. 7c and FIG. 9c show that the frame structure 620 may partly obstruct the opening in the top of the drawer 611. Retrieval of a storage container 106 placed in the drawer 611 may thus be prevented by the frame structure when the drawer 611 is in the picking position P_{P}. The storage container 106 should then be dimensioned to fit in the drawer 611 with less play than the area of the opening being obstructed.

The upper part 620a of the frame structure 620 may form a lower part of a port column 119. The upper part 620a of the frame structure 620 is preferably vertically aligned with the receiving position P_{R}.

FIG. 10a shows a top view of a portion of an automated storage and retrieval system 1. The automated storage and retrieval system 1 may comprise:
an access station 600 as described herein;
a rail system 108 comprising a first set of parallel rails 110 arranged in a horizontal plane P_{H} and extending in a first direction X and a second set of parallel rails 111 arranged in the horizontal plane P_{H} and extending in a second direction Y which is orthogonal to the first direction X, which first and second sets of rails 110, 111 form a grid in the horizontal plane P_{H} comprising a plurality of adjacent access openings 112;
a storage section comprising a plurality of storage containers 106 arranged in storage columns 105 located beneath the rail system 108, wherein each storage column 105 is located vertically below one of the plurality of access openings 112;
at least one port column 119 located beneath the rail system 108 and vertically aligned with a receiving position P_{R} of the access station 600, the at least one port column 119 being void of stored storage containers 106; and
a container handling vehicle 201;301;401 comprising a gripping device 304 for lifting storage containers 106 stored in the columns 105 above the storage section and drive means 201b,201c;301b,301c;401b,401c configured to drive the vehicle 301 along the rail system 108 in at least one of the first direction X and the second direction Y.

As illustrated in FIG. 10a, a plurality of access stations 600 may be arranged side-by-side as part of the same automated storage and retrieval system 1. In FIG. 10a, three access stations 600 are arranged side-by-side, however, any other number of access stations 600 may be used in the same automated storage and retrieval system 1. The access stations 600 can be arranged side-by-side or spaced apart.

In FIG. 10a, the drawers 611 are in their receiving positions P_{R} holding a storage container 106. As illustrated in FIG. 10a, each of the receiving positions P_{R} may be vertically aligned with a port column 119,120 of the automated storage and retrieval system 1. As illustrated in FIG. 10a, each of the receiving positions P_{R} may be vertically aligned with access openings 112 in the rail system 108 of the automated storage and retrieval system 1. In this way the container handling vehicles 201;301;401 driving on the rail system 108 may deliver and retrieve storage containers to/from the access station 600.

FIG. 10b is a top view of the automated storage and retrieval system of FIG. 10a, wherein the drawers 611 are in their picking positions P_{P}. As illustrated in FIG. 10b, each of the picking positions P_{P} may not be vertically aligned with a port column 119,120 of the automated storage and retrieval system 1. The storage containers 106 placed in the drawers 611 may thus not be accessible to the container handling vehicles 201;301;401 driving on the rail system 108. However, the storage containers 106 may be accessible to the user(s) of the access stations 600.

The above described automated storage and retrieval system may be operated as follows:
retrieving a storage container 106 stored in a storage section of the storage and retrieval system 1 by means of a container handling vehicle 201;301;401 comprising a gripping device 304;
moving a drawer 611 of the access station 600 to a receiving position P_{R};
placing the storage container 106 in a drawer 611 of the drawer assembly 610; and
moving the drawer 611 into a picking position P_{P} to present the storage container 106 to a user.

The method may, after presenting the storage container 106 to the user, comprise the steps of:
returning the drawer 611 to the receiving position P_{R}; and
retrieving the storage container 106 from the drawer 611.

In the preceding description, various aspects of the delivery vehicle and the automated storage and retrieval system according to the invention have been described with reference to the illustrative embodiment. For purposes of explanation, specific numbers, systems and configurations were set forth in order to provide a thorough understanding of the system and its workings. However, this description is not intended to be construed in a limiting sense. Various modifications and variations of the illustrative embodiment, as well as other embodiments of the system, which are apparent to persons skilled in the art to which the disclosed subject matter pertains, are deemed to lie within the scope of the present invention.

### List of Reference Numbers

1 Prior art automated storage and retrieval system
100 Framework structure
102 Upright members of framework structure
104 Storage grid
105 Storage column
106 Storage container
106′ Particular position of storage container
107 Stack
108 Rail system
110 Parallel rails in first direction (X)
112 Access opening
119 First port column
120 Second port column
201 Prior art container handling vehicle
201a Vehicle body of the container handling vehicle 201
201b Drive means/wheel arrangement/first set of wheels in first direction (X)
201c Drive means/wheel arrangement/second set of wheels in second direction (Y)
301 Prior art cantilever container handling vehicle
301a Vehicle body of the container handling vehicle 301
301b Drive means/first set of wheels in first direction (X)
301c Drive means/second set of wheels in second direction (Y)
304 Gripping device
401 Prior art container handling vehicle
401a Vehicle body of the container handling vehicle 401
401b Drive means/first set of wheels in first direction (X)
401c Drive means/second set of wheels in second direction (Y)
404 Gripping device
404a Lifting band
404b Gripper
404c Guide pin
404d Lifting frame
500 Control system
600 Access station
610 Drawer assembly
611 Drawer
612 Lower link
612a First end of the lower link
612b Second end of the lower link
612′ Plate/cover
613 Upper link
613a First end of the upper link
613b Second end of the upper link
620 Frame structure
620a Upper part of frame structure
621 Display
X First direction
Y Second direction
Z Third direction
P_{H} Horizontal plane
P_{R} Receiving position
P_{P} Picking position
W₇₁ Width of storage container
L₇₁ Length of storage container
H₇₁ Height of storage container
A₇₁ Area of storage container
L_{U} Length of upper link
L_{L} Length of lower link
D_{A} Horizontal distance between the first end of the lower link and the first end of the upper link
D_{B} Horizontal distance between the second end of the lower link and the second end of the upper link
D_{UR} Horizontal distance between the first end of the upper link and the second end of the upper link, in the receiving position
D_{UP} Horizontal distance between the first end of the upper link and the second end of the upper link, in the picking position
D_{LR} Horizontal distance between the first end of the lower link and the second end of the lower link, in the receiving position
D_{LP} Horizontal distance between the first end of the lower link and the second end of the lower link, in the picking position
α_{B} Drawer tilt angle
α_{UR} Upper link pivot angle in the receiving position relative to vertical
α_{UP} Upper link pivot angle in the picking position relative to vertical
α_{LR} Lower link pivot angle in the receiving position relative to vertical
α_{LP} Lower link pivot angle in the picking position relative to vertical

1-15. (canceled)

16. An access station for an automated storage and retrieval system, wherein the access station comprises:
a frame structure; and
a drawer assembly arranged in the frame structure,
wherein the drawer assembly comprises:
a drawer for accommodating a storage container;
a lower link pivotally coupled at a first end to the frame structure and pivotally coupled at a second end to the drawer; and
an upper link pivotally coupled at a first end to the frame structure and pivotally coupled at a second end to the drawer;
wherein the first end of the upper link is arranged higher than the second end of the upper link, and the first end of the lower link is arranged lower than the second end of the lower link;
wherein the drawer is movable between a receiving position for receiving a storage container from above, and a picking position for presenting a storage container to a user.

17. The access station according to claim 16, wherein the first end of the upper link is arranged above the drawer and the first end of the lower link is arranged below the drawer.

18. The access station according to claim 16, wherein the lower link has a lower link length and the upper link has an upper link length; and wherein a ratio between the lower link length and the upper link length is in a range of 1:1 to 1:2.

19. The access station according to claim 16, wherein the drawer is suspended by only the upper link and the lower link.

20. The access station according to claim 16, wherein the drawer is level in the receiving position (P_{R}).

21. The access station according to claim 16, wherein the first end of the upper link and the second end of the upper link are vertically aligned when the drawer is in a position between the picking position and the receiving position.

22. The access station according to claim 16, wherein the frame structure has a frontside and a backside; wherein when the drawer is in the receiving position, the second end of the lower link is closer to the backside of the frame structure than the first end of the lower link.

23. The access station according to claim 16, wherein the frame structure has a frontside and a backside; wherein when the drawer is in the picking position, the first end of the lower link is closer to the backside of the frame structure than the second end of the lower link.

24. The access station according to claim 16, wherein the access station is configured for vertical alignment of the receiving position with a port column of the automated storage and retrieval system for receiving storage containers therefrom.

25. The access station according to claim 16, wherein the frame structure and/or the drawer assembly are configured to prevent retrieval of a storage container from the drawer when the drawer is in the picking position.

26. An automated storage and retrieval system, wherein the automated storage and retrieval system comprises:
an access station according to any one of the preceding claims;
a rail system comprising a first set of parallel rails arranged in a horizontal plane and extending in a first direction and a second set of parallel rails arranged in the horizontal plane and extending in a second direction which is orthogonal to the first direction, which first and second sets of rails form a grid in the horizontal plane comprising a plurality of adjacent access openings;
a storage section comprising a plurality of storage containers arranged in storage columns located beneath the rail system;
wherein each storage column is located vertically below one of the plurality of adjacent access openings;
at least one port column located beneath the rail system and vertically aligned with a receiving position of the access station, the at least one port column being void of stored storage containers; and
a container handling vehicle comprising a gripping device for lifting storage containers stored in the storage columns above the storage section and drive means configured to drive the container handling vehicle along the rail system in at least one of the first direction and the second direction.

27. The automated storage and retrieval system according to claim 26, wherein the access station is configured to provide a lower section of the at least one port column.

28. The automated storage and retrieval system according to claim 26, wherein the automated storage and retrieval system comprises at least two access stations, preferably three or four access stations.

29. A method of presenting a storage container at an access station,
the access station being in an automated storage and retrieval system according to any one of claims 26-28;
wherein the method comprises:
retrieving a storage container stored in a storage section of the storage and retrieval system by means of a container handling vehicle comprising a gripping device;
moving a drawer of the access station to a receiving position;
placing the storage container in a drawer of the drawer assembly; and
moving the drawer into a picking position to present the storage container to a user.

30. The method according to claim 29, further comprising, after presenting the storage container to the user, returning the drawer to the receiving position and retrieving the storage container from the drawer.
